(19) United States
(12) Patent Application Publication
(10) Pub. No.: US 2011/0166288 A1
(43) Pub. Date: Jul. 7, 2011

(54) SILICONE ELASTOMERS WITH IMPROVED CRACK RESISTANCE

(75) Inventor: Christof Woerner, Burghausen (DE)

(73) Assignee: WACKER CHEMIE AG, Muenchen (DE)

(21) Appl. No.: 13/061,974

(22) PCT Filed: Aug. 31, 2009
(86) PCT No.: PCT/EP2009/061192

§ 371 Date: Mar. 3, 2011

(30) Foreign Application Priority Data
Sep. 10, 2008 (DE) 10 2008 041 940.0

(51) Int. Cl. C08L 83/07

(52) U.S. Cl. 524/547

(57) ABSTRACT

The object of the invention is addition cross-linkable silicone masses (M), comprising: A) 100 parts by weight of polydiorganosiloxane containing alkenyl groups, said siloxane having at least 2 alkenyl groups per molecule, a viscosity of at least 1 000 000 mPa·s and at most 0.3 mol-% alkenyl groups, B) SiH-functional cross-linking agents, C) hydrosilylation catalyst, D) 10-80 parts by weight of a stiffening filler having a specific surface area of 50 m2/g to 350 m²/g and E) silicon oil with a viscosity of 20-5000 mPa·s, the radicals thereof being selected from phenyl and C₁₋₆ alkyl radicals, wherein at least 5 mol-% of all radicals are phenyl radicals, a method for manufacturing the addition cross-linkable silicone masses (M), silicone elastomers obtained through the cross-linking of addition cross-linkable silicone masses (M).

The invention relates to addition-crosslinkable silicone compositions (M) which crosslink to give silicone elastomers having good cut resistance, to a method for producing the addition-crosslinkable silicone compositions (M), and to the crosslinked silicone elastomers.

Ready-made silicone elastomers, on contact with sharp-edged objects, such as blades, sharp-edged profiles or metal parts, for example, are known to have a cut resistance which in many applications is inadequate. This results, time and again, in instances of damage to the ready-made parts when they come into contact, in the course of assembly, for example, with a sharp metal or plastics part. Seals of silicone rubber are often combined with metal or plastics parts to form two-component assemblies, the silicone seal being pushed over a sharp-edged, ready-made metal or plastics part, or a sharp, ready-made metal or plastics part being pushed through a cavity in the silicone seal. Here, time and again, there are instances of damage to the silicone seal, and hence of destruction of the two-component assembly.

Although this phenomenon is known, there are nevertheless few indications in the literature as to how the cut resistance of silicone elastomers may be improved.

In the case of gloves made from organic rubbers, the cut resistance is improved, for example, through insertion of metal wires or fibers (EP1911866).

WO 99/18156 improves the cut resistance of organic rubbers and silicone elastomers through the addition of fillers having a Mohs hardness of at least 3. This is done using, preferably, platelet-shaped inert fillers of metal, ceramic or crystalline minerals. Through the use of these inactive fillers, however, the mechanical properties that can be realized are no more than moderate. Moreover, these materials are difficult to process by injection molding, since the fillers used have a very high abrasiveness.

Watanabe describes in JP 07082488 how mica and polydimethylsiloxane oils can be used to improve the cut resistance of peroxidically crosslinking solid silicone rubbers. When mica is used, however, only average mechanical properties are produced. For numerous applications, however, there is a need for silicone elastomers which can be crosslinked rapidly, have excellent tensile strength and elongation at break, and also exhibit a significantly improved cut resistance.

The present invention is based on the object of providing addition-crosslinkable silicone compositions which crosslink rapidly to form silicone elastomers having good cut resistance and which also possess good mechanical properties.

The invention provides addition-crosslinkable silicone compositions (M) comprising
(A) 100 parts by weight of polydiorganosiloxane containing alkenyl groups, having at least 2 alkenyl groups per molecule, a viscosity of at least 1 000 000 mPa·s, and not more than 0.3 mol % of alkenyl groups,
(B) SiH-functional crosslinking agent,
(C) hydrosilylation catalyst,
(D) 10-80 parts by weight of a reinforcing filler having a specific surface area of 50 m²/g to 350 m²/g, and
(E) silicone oil having a viscosity of 20-5000 mPa·s, its radicals being selected from phenyl radicals and C₁₋₆ alkyl radicals, with at least 5 mol % of all of the radicals being phenyl radicals.

The addition-crosslinkable silicone compositions (M) crosslink to give silicone elastomers having good cut resistance, and also possessing good mechanical properties.

The crosslinked silicone elastomers preferably possess a hardness of at least 3, more preferably at least 5, more particularly at least 10 Shore A, and preferably not more than 70, more preferably not more than 60, more particularly not more than 50 Shore A.

The polydiorganosiloxane (A) containing alkenyl groups that is present in the addition-crosslinkable silicone compositions (M) may be composed of one polymer or of a mixture of polymers. In a mixture, however, all of the constituents must have at least 2 alkenyl groups per molecule and not more than 0.3 mol % of alkenyl groups.

In the polydiorganosiloxane (A) containing alkenyl groups the alkenyl groups are preferably terminal. The alkenyl groups are more particularly vinyl groups or allyl groups. The pendant groups are preferably C₁₋₆ alkyl groups or alkenyl groups, more particularly methyl, ethyl, vinyl or allyl groups.

The polyorganosiloxane (A) containing alkenyl groups preferably has a viscosity of at least 2 000 000 mPa·s, more preferably at least 5 000 000 mPa·s, and preferably not more than 50 000 000 mPa·s.

The polyorganosiloxane (A) containing alkenyl groups preferably has per molecule not more than 0.2 mol %, more preferably not more than 0.15 mol %, of alkenyl groups. Polyorganosiloxane (A) preferably carries no pendant vinyl groups.

The polydiorganosiloxane (A) preferably has a Si-bonded OH content of not more than 100 ppm by weight. With particular preference the OH content is <50 ppm by weight.

The SiH-functional crosslinking agent (B) is preferably an organosilicon compound or a mixture of at least two organosilicon compounds which comprise at least two, preferably at least three, silicon-bonded hydrogen atoms per molecule.

The crosslinking agent (B) is used preferably in the silicone compositions (M) in an amount such that the ratio of its silicon-bonded hydrogen atoms to the sum of the alkenyl groups of the polyorganosiloxanes (A)+carbon-carbon multiple bonds of the fillers (D) is at least 1.1:1, preferably not more than 5:1, more particularly not more than 3:1.

The crosslinking agent (B) is composed preferably of units of the average general formula (1)

HₐR¹_{b}SiO_{(4-a-b)/2} (1)
where
R¹ denotes monovalent, optionally halogen- or cyano-substituted, SiC-bonded C₁-C₁₀ hydrocarbon radicals which are free from aliphatic carbon-carbon multiple bonds,
a is 0, 1, 2 or 3,
b is 0, 1, 2 or 3, and
the sum a+b≦3,
   with the proviso that there are at least two silicon-bonded hydrogen atoms per molecule.

Examples of unsubstituted radicals R¹ are alkyl radicals, such as the methyl, ethyl, n-propyl, iso-propyl, n-butyl, isobutyl, tert-butyl, n-pentyl, iso-pentyl, neopentyl, tert-pentyl radical, hexyl radicals, such as the n-hexyl radical, heptyl radicals, such as the n-heptyl radical, octyl radicals, such as the n-octyl radical and isooctyl radicals, such as the 2,2,4-trimethylpentyl radical, nonyl radicals, such as the n-nonyl radical, decyl radicals, such as the n-decyl radical;

cycloalkyl radicals, such as cyclopentyl, cyclohexyl, 4-ethylcyclohexyl, cycloheptyl radicals, norbornyl radicals, and methylcyclohexyl radicals; aryl radicals, such as the phenyl, biphenylyl, naphthyl radical; alkaryl radicals, such as o-, m-, p-tolyl radicals and ethylphenyl radicals; aralkyl radicals, such as the benzyl radical, the alpha- and the β-phenylethyl radical.

Examples of substituted hydrocarbon radicals as radicals R¹ are halogenated hydrocarbon radicals, such as the chloromethyl, 3-chloropropyl, 3-bromopropyl, 3,3,3-trifluoropropyl and 5,5,5,4,4,3,3-hexafluoro-pentyl radical, and also the chlorophenyl, dichloro-phenyl, and trifluorotolyl radical.

R¹ preferably has 1 to 6 carbon atoms. More particularly preferred are methyl, 3,3,3-tri-fluoropropyl, and phenyl.

The hydrogen content of the crosslinking agent (B), which relates exclusively to the hydrogen atoms attached directly to silicon atoms, is preferably in the range from 0.002% to 1.7% by weight of hydrogen, more preferably from 0.1% to 1.7% by weight of hydrogen.

The crosslinking agent (B) preferably comprises at least three and not more than 600 silicon atoms per molecule. Particularly preferred is the use of crosslinking agents (B) which comprise 4 to 200 silicon atoms per molecule.

The structure of the crosslinking agent (B) may be linear, branched, cyclic or networklike.

Particularly preferred crosslinking agents (B) are linear polyorganosiloxanes of the average general formula (2)

(R²₃SiO_{1/2})_{d}(HR²SiO_{2/2})ₑ(R²₂SiO_{2/2})_{f} (2)
in which
   R² has the definitions of R¹ and
   d, e, and f denote the value 0 or positive integers, with the proviso that the equations d=2, e>2, 5<(e+f)<200, and 0.1<e/(e+f)<1 are met.

As hydrosilylation catalyst (C) it is possible with preference to use all known catalysts which catalyze the hydrosilylation reactions that take place in the crosslinking of addition-crosslinking silicone compositions (M).

The hydrosilylation catalysts (C) are selected more particularly from the metals platinum, rhodium, palladium, ruthenium, and iridium and from compounds thereof.

Preference is given to using platinum or compounds of platinum. Particular preference is given to those compounds of platinum which are soluble in polyorganosiloxanes. Soluble platinum compounds which may be used include, for example, the platinum-olefin complexes of the formulae (PtCl₂.olefin)₂ and H(PtCl₃.olefin), in which case, preferably, alkenes having 2 to 8 carbon atoms, such as ethylene, propylene, isomers of butene and of octene, or cycloalkenes having 5 to 7 carbon atoms, such as cyclopentene, cyclohexene, and cycloheptene, are used. Other soluble platinum catalysts are the platinum-cyclopropane complex of the formula (PtCl₂C₃H₆)₂, the reaction products of hexachloroplatinic acid with alcohols, ethers, and aldehydes and/or mixtures thereof, or the reaction product of hexachloroplatinic acid with methylvinyl-cyclotetrasiloxane in the presence of sodium bicarbonate in ethanolic solution. Particularly preferred are complexes of platinum with vinylsiloxanes, such as sym-divinyltetramethyl-disiloxane. Likewise very suitable are the platinum compounds described in EP 1 077 226 A1 and EP 0 994 159 A1, whose relevant disclosure content is incorporated into the present specification.

The hydrosilylation catalyst (C) may be used in any desired form, including, for example, in the form of hydrosilylation catalyst-containing microcapsules, or polyorganosiloxane particles, as described in EP 1 006 147 A1, whose relevant disclosure content is incorporated into the present specification.

The amount of hydrosilylation catalysts (C) is selected such that the addition-crosslinkable silicone composition (M) preferably possesses a Pt content of 0.1 to 200 ppm, more preferably of 0.5 to 40 ppm.

The addition-crosslinkable silicone compositions (M) comprise preferably at least 15, more preferably at least 20 parts by weight, and preferably not more than 70, more preferably not more than 60, parts by weight of reinforcing filler (D).

The specific surface area of the reinforcing filler (D) is preferably at least 100, more preferably at least 120 m²/g and preferably not more than 350, more preferably not more than 250 m²/g.

The reinforcing filler (D) is preferably selected from precipitated and fumed silicas and also carbon black.

Preference is given to precipitated and fumed silicas, and also mixtures thereof. Particular preference is given to fumed silicas surface-treated with silylating agent. The silica may be rendered hydrophobic either prior to incorporation into the polyorganosiloxane, or else in the presence of a polyorganosiloxane, by the in situ method. Both methods may be carried out either in a batchwise operation or else continuously. Silylating agents that can be used are all of the hydrophobing agents known to the skilled person, and water, additionally, may be used as well. Silylating agents are preferably silazanes, more particularly hexamethyl-disilazane and/or 1,3-divinyl-1,1,3,3-tetramethyl-disilazane, and/or polysilazanes. In addition it is also possible for other silylating agents, such as, for example, SiOH- and/or SiCl- and/or alkoxy-functional silanes and/or siloxanes, to be used as hydrophobing agents. Similarly, cyclic, linear or branched non-functional organosiloxanes, such as octamethylcyclo-tetrasiloxane or polydimethylsiloxane, for example, may be used as silylating agents, in each case per se or in addition to silazanes. In order to accelerate the hydrophobization, the use of catalytically active additives, such as hydroxides, for example, is also possible. The hydrophobizing may take place in one step using one or more hydrophobing agents, but also using one or more hydrophobing agents in two or more steps.

Preference is given to precipitated or fumed silicas. Particularly preferred is a silica having a specific surface area by the BET method of 80-350 m²/g, more preferably 100-300 m²/g.

The addition-crosslinkable silicone compositions (M) comprise preferably at least one, more preferably at least 3, more particularly at least 5, and preferably not more than 30, more preferably not more than 15, more particularly not more than 10 parts by weight of silicone oil (E).

The silicone oil (E) preferably has a viscosity of at least 50 mPa·s, more preferably at least 100 mPa·s, and preferably not more than 2000 mPa·s, more preferably not more than 1000 mPa·s.

Preferably at least 15 mol %, more preferably at least mol %, and preferably not more than 80 mol %, more preferably not more than 60 mol %, of all of the radicals in the silicone oil (E) are phenyl radicals.

In the silicone oil (E) the C₁₋₆ alkyl groups are selected preferably from methyl groups and ethyl groups.

The silicone oil (E) is preferably constructed of units selected from trimethylsiloxy, diphenylsiloxy, phenyl-methylsiloxy, and dimethylsiloxy units.

The addition-crosslinkable silicone compositions (M) may optionally comprise as further constituent (F) possible additions in a fraction of 0 to 150 parts by weight, preferably 0.0001 to 50 parts by weight. These additions may be, for example, resinlike polyorgano-siloxanes different from the polyorganosiloxanes (A), (B), and (E), dispersing assistants, solvents, adhesion promoters, pigments, dyes, plasticizers, organic polymers, heat stabilizers, inhibitors, etc. These include additions such as dyes, pigments, etc. As a constituent there may additionally be thixotropic constituents present, such as highly disperse silica or other commercial thixotropic additives.

Further additions may be present which serve for the specific setting of the processing life, onset temperature, and crosslinking rate of the crosslinking compositions. These inhibitors and stabilizers are very well known in the field of crosslinking compositions.

In addition it is also possible for additives to be added, such as, for example, the sulfur compounds which are described in EP 0 834 534 A1, whose relevant disclosure content is also incorporated into the present specification, and which improve the compression set. Additionally it is also possible for hollow bodies, including expandable hollow bodies, to be added. Additionally, blowing agents may be added for the purpose of generating foams.

The present invention further provides a method for producing the addition-crosslinkable silicone compositions (M), a method for producing the crosslinked silicone elastomers from the addition-crosslinkable silicone compositions (M), and the silicone elastomer moldings thus obtainable.

The production or compounding of the silicone compositions is accomplished preferably by mixing the polyorganosiloxane (A), the silicone oil (E), and filler (D). Crosslinking following addition of crosslinking agent (B) and hydrosilylation catalyst (C) is accomplished preferably by heating, preferably at 30 to 250° C., more preferably at not less than 50° C., more particularly at not less than 100° C., preferably at 150-210° C.

The addition-crosslinkable silicone compositions (M) are suitable for producing addition-crosslinking HTV compositions, with preferably the first component, in addition to the hydrosilylation catalyst (C), and the second component comprising the SiH crosslinker (B). When 1K (one-component) catalysts are used, as described in EP 1 077 226 A1 and EP 0 994 159 A1, for example, it is also possible for one-component mixtures to be produced.

For this purpose the moldings are produced preferably by means of injection molding from the HTV compositions produced using the addition-crosslinkable silicone compositions (M). For example, from the addition-crosslinkable silicone compositions (M), it is possible in this way to obtain seals which are notable more particularly for their excellent incision resistance.

All of the above symbols in the above formulae have their definitions in each case independently of one another. In all formulae the silicon atom is tetravalent.

In the inventive and comparative examples below it is the case, unless indicated otherwise specifically, that all quantity figures and percentage figures are given by weight, and all reactions are carried out under a pressure of 0.10 MPa (abs.) and at a temperature of 20° C. In the text below, all viscosity figures are based on a temperature of 25° C.

### EXAMPLES

### Example 1* (Not Inventive)

### Preparation of the Base Composition 1:

A laboratory kneading apparatus was charged with 260 g of a vinyldimethylsiloxy-terminated polydimethylsiloxane having a viscosity of 100 000 mPa·s (25° C.) (vinylsiloxy content of 0.16 mol %), which was heated to 150° C. and admixed with 80 g of a fumed silica hydrophobized with hexamethyldisilazane and having a BET specific surface area of 150 m²/g and a carbon content of 3.2% by weight. This produced a highly viscous composition which was subsequently heated at 150° C. by kneading under reduced pressure (10 mbar) over the course of an hour in order to remove volatile constituents.

### Production of the Crosslinkable Mixture:

330 g of base composition were admixed with 0.30 g of ethynylcyclohexanol, 4.5 g of a copolymer made up of dimethylsiloxy, methylhydrosiloxy, and trimethylsiloxy units and having a viscosity of 250 mPa·s at 25° C. and an SiH content of 0.48% by weight, 0.48 g of a platinum-sym-divinyltetramethyldisiloxane complex solution containing 1% by weight of Pt, and 16.5 g of a trimethylsiloxy-terminated polydiorganosiloxane with 33 mol % of diphenylsiloxy units and 66 mol % of dimethylsiloxy units, and with a viscosity of 200 mPa·s (25° C.).

The silicone composition produced in this way was subsequently crosslinked in a hydraulic press at a temperature of 165° C. over the course of 15 minutes, and subsequently heated at 200° C. for 4 hours.

### Example 2* (Not Inventive)

### Preparation of the Base Composition 2:

In contrast to example 1, the base composition 2 was prepared using not a vinyldimethylsiloxy-terminated polydimethylsiloxane having a viscosity of 100 000 mPa·s (25° C.) but instead a vinyldimethylsiloxy-terminated polydimethylsiloxane having a viscosity of 14 000 000 mPa·s (25° C.) and additionally containing vinylmethylsiloxy units in the polymer chain, and a vinylsiloxy units fraction of 0.4 mol %.

The production of the crosslinkable mixture, and the crosslinking and also subsequent heating of the addition-crosslinking composition, took place as described in example 1.

### Example 3

### Preparation of the Base Composition 3:

In contrast to example 1, the base composition 3 was prepared using not a vinyldimethylsiloxy-terminated polydimethylsiloxane having a viscosity of 100 000 mPa·s (25° C.) but instead a vinyldimethylsiloxy-terminated polydimethylsiloxane having a viscosity of 16 000 000 mPa·s (25° C.) and additionally containing vinylmethylsiloxy units in the polymer chain, and a vinylsiloxy units fraction of 0.12 mol %.

The production of the crosslinkable mixture, and the crosslinking and also subsequent heating of the addition-crosslinking composition, took place as described in example 1.

TABLE 1

| | | Tear | | | |
|---|---|---|---|---|---|
| | | propagation | | | Cut |
| | | resistance | | | resistance |
| | | (ASTM | Tensile | Elongation | [depth of |
| | Hardness | D624) | strength | at break | penetration |
| | (Shore A) | [N/mm] | [N/mm²] | [%] | in mm] |
| Example | 31 | 15 | 7.5 | 650 | 2 |
| 1* | | | | | |
| Example | 33 | 25 | 9.5 | 750 | 4 |
| 2* | | | | | |
| Example | 30 | 18 | 8.5 | 800 | 10 |
| 3 | | | | | |

*not inventive

From table 1 it is evident that by using a high-viscosity, low-vinyl polydiorganosiloxane it is possible to improve the cut resistance significantly.

### Example 4

### Preparation of the Base Composition 4:

In contrast to example 1, the base composition 4 was prepared using not a vinyldimethylsiloxy-terminated polydimethylsiloxane having a viscosity of 100 000 mPa·s (25° C.) but instead a vinyldimethylsiloxy-terminated polydimethylsiloxane having a viscosity of 15 000 000 mPa·s (25° C.) and additionally containing vinylmethylsiloxy units in the polymer chain, and a vinylsiloxy units fraction of 0.08 mol %, and also the fumed silica described in example 1, but with a surface area of 200 m²/g.

The production of the crosslinkable mixture, and the crosslinking and also subsequent heating of the addition-crosslinking composition, took place as described in example 1.

### Example 5* (Not Inventive)

330 g of the base composition 4 described in example 4 were admixed with 16.5 g of the phenylsilicone oil specified in example 1. Crosslinking, however, took place not as described in example 1, by addition of Pt catalyst, SiH crosslinker, and ethynylcyclohexanol inhibitor. Instead, 2.3 g of dicumyl peroxide were added. Crosslinking and heating took place as described in example 1.

TABLE 2

| | | Tear | | | |
|---|---|---|---|---|---|
| | | propagation | | | Cut |
| | | resistance | | | resistance |
| | | (ASTM | Tensile | Elongation | [depth of |
| | Hardness | D624) | strength | at break | penetration |
| | (Shore A) | [N/mm] | [N/mm²] | [%] | in mm] |
| Example | 33 | 19 | 10.0 | 850 | 11 |
| 4 | | | | | |
| Example | 35 | 18 | 9.5 | 750 | 5 |
| 5* | | | | | |

*not inventive

From table 2 it is evident that, through crosslinking via addition crosslinking in comparison to peroxidically crosslinking silicone elastomers, it is possible to realize a significantly increased cut resistance.

### Example 6* (Not Inventive)

### Preparation of the Base Composition 6:

In contrast to example 3, the base composition was prepared using not a silica having a BET surface area of 150 m²/g but instead a fumed silica hydrophobized with hexamethyldisilane and having a BET specific surface area of 400 m²/g and a carbon content of 3.9% by weight.

The production of the crosslinkable mixture, the crosslinking, and the subsequent heating of the addition-crosslinking composition took place as described in example 1.

TABLE 3

| | | Tear | | | |
|---|---|---|---|---|---|
| | | propagation | | | Cut |
| | | resistance | | | resistance |
| | | (ASTM | Tensile | Elongation | [depth of |
| | Hardness | D624) | strength | at break | penetration |
| | (Shore A) | [N/mm] | [N/mm²] | [%] | in mm] |
| Example | 30 | 18 | 8.5 | 800 | 10 |
| 3 | | | | | |
| Example | 33 | 19 | 10.0 | 850 | 11 |
| 4 | | | | | |
| Example | 35 | 22 | 8.9 | 820 | 7 |
| 6* | | | | | |

*not inventive

From table 3 it is evident that, through use of a fumed silica having a BET surface area of 150 or 200 m²/g, better cut resistances are generated than when using fumed silicas having a very high specific BET surface area of 400 m²/g.

### Example 7* (Not Inventive)

In contrast to example 4, the phenylsilicone oil described in example 1 was not added during the production of the crosslinkable mixture. The crosslinking and also the subsequent heating of the addition-crosslinking composition took place as described in example 1.

### Example 8* (Not Inventive)

In contrast to example 4, the production of the crosslinkable mixture was carried out with addition not of the phenylsilicone oil described in example 1, but instead of 16.5 g of a trimethylsiloxy-terminated polydimethylsiloxane having a viscosity of 200 mPa·s (25° C.).

The crosslinking and also the subsequent heating of the addition-crosslinking composition took place as described in example 1.

TABLE 4

| | | Tear | | | |
|---|---|---|---|---|---|
| | | propagation | | | Cut |
| | | resistance | | | resistance |
| | | (ASTM | Tensile | Elongation | [depth of |
| | Hardness | D624) | strength | at break | penetration |
| | (Shore A) | [N/mm] | [N/mm²] | [%] | in mm] |
| Example | 33 | 19 | 10.0 | 850 | 11 |
| 4 | | | | | |
| Example | 36 | 18 | 9.8 | 870 | 7 |
| 7* | | | | | |
| Example | 33 | 19 | 9.7 | 820 | 6 |
| 8* | | | | | |

*not inventive

From table 4 it is evident that by adding the phenyl-silicone oil, a considerable improvement is obtained in the cut resistance.

### Example 9

### Preparation of the Base Composition 9:

In a kneading apparatus, 260 g of a vinyldimethylsiloxy-terminated polydimethylsiloxane having a viscosity of 15 000 000 mPa·s, which additionally possesses vinylmethylsiloxy units in the polymer chain and has a vinylsiloxy units fraction of 0.10 mol %, were kneaded with 20.6 g of α,ω-dihydroxypolydimethylsiloxane having a viscosity of 40 mPa·s, which is required for the hydrophobization of the fumed silica, and with 62.1 g of fumed silica having a BET specific surface area of 150 m²/g, at 150° C. for one hour.

The production of the crosslinkable mixture, the crosslinking, and also the subsequent heating of the addition-crosslinking composition took place as described in example 1.

### Example 10

### Preparation of the Base Composition 10:

In contrast to the preparation of the base composition 9, instead of 20.6 g of α,ω-dihydroxy-polydimethylsiloxane, 15.4 g of α,ω-dihydroxy-polydimethylsiloxane having a viscosity of 40 mPa·s and 7.7 g of α,ω-dihydroxypolyorganosiloxane with 30 mol % of vinylmethyl units and 70 mol % of dimethylsiloxy units and with a viscosity of 45 mPa·s were used in order to hydrophobize the fumed silica. Moreover, instead of the fumed silica having a specific surface area of 150 m²/g, 68.0 g of fumed silica having a surface area of 200 m²/g were used.

The production of the crosslinkable mixture, the crosslinking, and also the subsequent heating of the addition-crosslinking composition took place as described in example 1.

TABLE 5

| | | Tear | | | |
|---|---|---|---|---|---|
| | | propagation | | | Cut |
| | | resistance | | | resistance |
| | | (ASTM | Tensile | Elongation | [depth of |
| | Hardness | D624) | strength | at break | penetration |
| | (Shore A) | [N/mm] | [N/mm²] | [%] | in mm] |
| Example | 29 | 25 | 10.1 | 950 | 12 |
| 9 | | | | | |
| Example | 52 | 31 | 11.2 | 780 | 10 |
| 10 | | | | | |

From table 5 it is evident that the cut resistance can be improved, particularly in the low and middle hardness range from 20 to 60 Shore A.

The silicone elastomer properties were characterized in accordance with DIN 53505 (Shore A), DIN 53504-S1 (tensile strength and elongation at break), and ASTM D 624 B (tear propagation resistance).

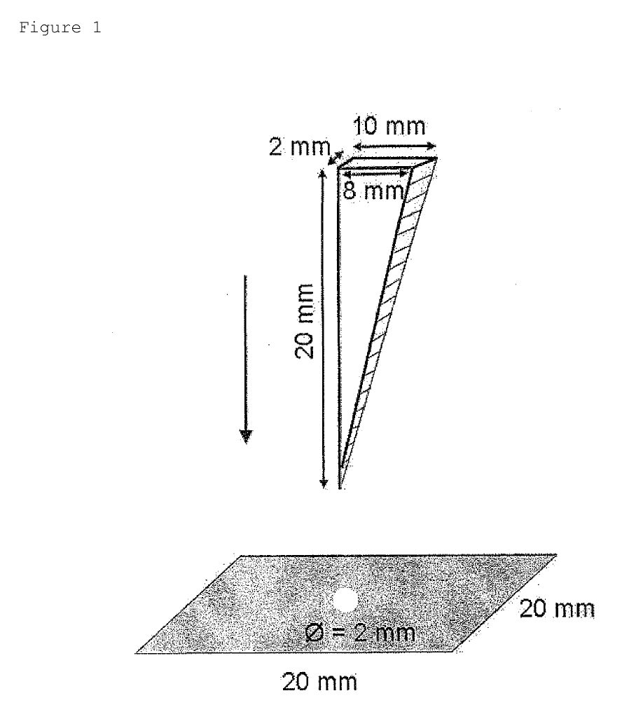

The cut resistance was determined as shown in FIG. 1: 20×20 mm specimens having a thickness of 2 mm and a cavity in the middle with a diameter of 2 mm were produced. A tool with a sharp edge on one side, as shown in FIG. 1, was introduced into the cavity with a speed of 10 mm/min. A determination was made of the depth of penetration at which a crack is initiated in the silicone elastomer. 5 specimens in each case were characterized, and the average from these 5 measurements was taken for the purpose of assessment.

1. An addition-crosslinkable silicone composition (M) comprising
(A) 100 parts by weight of polydiorganosiloxane containing alkenyl groups, having at least 2 alkenyl groups per molecule, a viscosity of at least 1,000,000 mPa·s, an OH content less than 50 ppm by weight, and not more than 0.3 mol % of alkenyl groups,
(B) SiH-functional crosslinking agent,
(C) hydrosilylation catalyst,
(D) 10-80 parts by weight of a reinforcing filler having a specific surface area of 50 m²/g to 350 m²/g, and
(E) silicone oil having a viscosity of 20-5000 mPa·s, and having radicals selected from the group consisting of phenyl radicals and C₁₋₆ alkyl radicals, with at least 5 mol % of all of the radicals being phenyl radicals.

2. The addition-crosslinkable silicone composition (M) as claimed in claim 1, wherein the alkenyl groups in the polydiorganosiloxane (A) containing alkenyl groups are vinyl groups or allyl groups.

3. The addition-crosslinkable silicone composition (M) as claimed in claim 1, wherein the SiH-functional crosslinking agent (B) is an organosilicon compound or a mixture of at least 2 organosilicon compounds which comprise at least two silicon-bonded hydrogen atoms per molecule.

4. The addition-crosslinkable silicone composition (M) as claimed in claim 1, wherein the hydrosilylation catalysts (C) are metals selected from the group consisting of platinum, rhodium, palladium, ruthenium, and iridium and from compounds thereof.

5. The addition-crosslinkable silicone composition (M) as claimed in claim 1, wherein the reinforcing filler (D) is a member selected from the group consisting of precipitated silicas, fumed silicas and carbon black.

6. The addition-crosslinkable silicone composition (M) as claimed in claim 1, which comprises 3 to 15 parts by weight of silicone oil (E).

7. The addition-crosslinkable silicone composition (M) as claimed in claim 1, wherein the silicone oil (E) is constructed of units selected from the group consisting of trimethylsiloxy, diphenylsiloxy, phenylmethylsiloxy, and dimethylsiloxy units.

8. A method for producing the addition-crosslinkable silicone composition (M) as claimed in claim 1, wherein polyorganosiloxane (A), silicone oil (E), and filler (D) are mixed and subsequently crosslinking agent (B) and hydrosilylation catalyst (C) are added.

9. A silicone elastomer obtainable by crosslinking the addition-crosslinkable silicone composition (M) as claimed in claim 1.
